(19) United States
(12) Patent Application Publication
(10) Pub. No.: US 2023/0385829 A1
(43) Pub. Date: Nov. 30, 2023

(54) METHODS FOR PROVIDING CONTEXTUAL NOTIFICATIONS IN A WEB BROWSER SESSION

(71) Applicant: The Toronto-Dominion Bank, Toronto (CA)

(72) Inventors: Rachel CURWEN, Toronto (CA); Shuyan LIN, Markham (CA); Devanshi PALIWAL, Brampton (CA)

(73) Assignee: The Toronto-Dominion Bank, Toronto (CA)

(21) Appl. No.: 17/825,641

(22) Filed: May 26, 2022

(51) Int. Cl. G06Q 20/40; G06Q 40/02; G06Q 40/06

(52) U.S. Cl. CPC G06Q 20/4014; G06Q 40/02; G06Q 40/06

(57) ABSTRACT

A computer-implemented method is disclosed. The method includes: receiving, via a browser application on a computing device, a request to retrieve a first web page from a web server; determining that the first web page is associated with a first merchant; in response to determining that the first web page is associated with the first merchant: obtaining historical transactions data of a resource account associated with the computing device; determining a first allocation of resources associated with the resource account; detecting a user action in the browser application for interacting with the web page; in response to detecting the user action in the browser application: identifying at least one product associated with the merchant based on the detected user action; generating a notification associated with the identified at least one product based on the historical transactions data of the resource account and the first allocation of resources; and providing, to the computing device for display in the browser application, the generated notification.

### TECHNICAL FIELD

The present application relates to user interfaces and, more particularly, to a system and methods for processing user interactions with web browsers.

### BACKGROUND

Web browsers facilitate user interaction with web pages. When rendering web page content, a web browser attempts to present the information as intended by the developers of the web page. For example, a web browser enables access to page actions which are programmed by the developers for allowing users to interact with a web page. Page actions may range from a simple navigation action (e.g., clicking a link) to user input of text, images, biometrics, etc. Web browsers typically do not display information in addition to what is explicitly programmed by the developers of web pages. In particular, web browsers may not present customized information relating to page actions on a web page and the effects of the page actions for individual visitors of the web page.

### BRIEF DESCRIPTION OF THE DRAWINGS

Reference will now be made, by way of example, to the accompanying drawings which show example embodiments of the present application and in which:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method for generating contextual notifications in a web browser session;

FIG. 4 shows, in flowchart form, an example method for generating contextual notifications based on user-initiated page actions in connection with a web page;

FIG. 5 shows, in flowchart form, an example method for controlling a user interface associated with a web page; and

FIG. 6 shows, in flowchart form, an example method for updating account data of a resource account based on page actions associated with a web page.

Like reference numerals are used in the drawings to denote like elements and features.

### DETAILED DESCRIPTION OF EXAMPLE EMBODIMENTS

In an aspect, a computing system is disclosed. The computing system includes a processor and a memory coupled to the processor. The memory stores instructions that, when executed by the processor, configure the processor to: receive, via a browser application on a computing device, a request to retrieve a first webpage from a web server; determine that the first webpage is associated with a first merchant; in response to determining that the first webpage is associated with the first merchant: obtain historical transactions data of a resource account associated with the computing device; determine a first allocation of resources associated with the resource account; detect a user action in the browser application for interacting with the first webpage; in response to detecting the user action in the browser application: identify at least one product associated with the merchant based on the detected user action; generate a notification associated with the identified at least one product based on the historical transactions data of the resource account and the first allocation of resources; and provide, to the computing device for display in the browser application, the generated notification.

In some implementations, providing the generated notification to the computing device may include transmitting an instruction to present the notification in a graphical user interface associated with the browser application on the computing device.

In some implementations, the historical transactions data may include a list of transactions in connection with the first merchant and wherein detecting the user action comprises determining that the user has navigated to the first web page associated with the first merchant.

In some implementations, detecting the user action may include detecting that the user has navigated to a product page of a product offered by the first merchant.

In some implementations, the first allocation of resources may include an indication of a defined quantity of resources associated with one or more categories of resource allocation.

In some implementations, detecting the user action may include detecting selection of a user interface element associated with a product that is displayed on the first web page.

In some implementations, the instructions, when executed, may further configure the processor to obtain historical user activity data in connection with the first web page and the notification may be generated based at least in part on the historical user activity.

In some implementations, determining that the first web page is associated with the first merchant may include at least one of contextual scanning of the first web page or parsing of web page metadata of the first web page.

In some implementations, the instructions, when executed, may further configure the processor to determine whether the request is received from an authenticated user associated with the resource account.

In some implementations, generating the notification may include: identifying a category of resource allocation that is associated with a user action on the first web page; and comparing a quantity of resources associated with said category to a respective quantity defined by the first allocation.

In another aspect, a computer-implemented method is disclosed. The method includes: receiving, via a browser application on a computing device, a request to retrieve a first web page from a web server; determining that the first web page is associated with a first merchant; in response to determining that the first web page is associated with the first merchant: obtaining historical transactions data of a resource account associated with the computing device; determining a first allocation of resources associated with the resource account; detecting a user action in the browser application for interacting with the web page; in response to detecting the user action in the browser application: identifying at least one product associated with the merchant based on the detected user action; generating a notification associated with the identified at least one product based on the historical transactions data of the resource account and the first allocation of resources; and providing, to the computing device for display in the browser application, the generated notification.

In another aspect, a non-transitory computer readable storage medium is disclosed. The computer readable storage medium contains instructions thereon that, when executed by a processor, configure the processor to: receive, via a browser application on a computing device, a request to retrieve a first web page from a web server; determine that the first web page is associated with a first merchant; in response to determining that the first web page is associated with the first merchant: obtain historical transactions data of a resource account associated with the computing device; determine a first allocation of resources associated with the resource account; detect a user action in the browser application for interacting with the first web page; in response to detecting the user action in the browser application: identify at least one product associated with the merchant based on the detected user action; generate a notification associated with the identified at least one product based on the historical transactions data of the resource account and the first allocation of resources; and provide, to the computing device for display in the browser application, the generated notification.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Web browsers allow users to access and interact with web page content. Web browsers retrieve content from web servers and render the content on user devices. Specifically, a rendering engine of a web browser processes web (e.g., HTML) documents and transforms the documents and other resources of web pages into an interactive visual representation that is displayed on user devices.

While web browsers support displaying a wide range of data types, they are generally limited in providing customized, page- and user-specific notifications. Web pages are displayed using assistive technologies for standardizing the display of web page content across different devices. In particular, web browsers attempt to display the information on web pages, such as text, videos, images, hyperlinks, etc., as intended by developers of the web pages in a standardized way. Web browsers are not generally designed to present user-specific information on display of web pages.

Visitors of a web page may interact with the page content differently, and the page actions of users on a web page may affect account data of user accounts which may be associated with the web page. In order to ascertain the effects of page actions on account data, users may need to log in to their accounts independently of their interactions with the web page using a web browser. Users may, for example, conduct certain page actions (e.g., a product purchase, transfer of funds, etc.) on a web page, and the effects of the page actions on account data of a user account may be monitored by logging in to and accessing an account details page associated with the user account.

The need for separately monitoring account data imposes burdens on users of web browsers. In particular, users must take additional steps after conducting page actions on a web page to determine the effects of the page actions on their account data. Furthermore, this a posteriori approach to managing account data limits the capacity of web browsers to provide users with useful predictive information about page actions of web pages and their effects on related user accounts.

The present application describes solutions for addressing some of the aforementioned technical limitations associated with conventional web browsers. The disclosed system and methods allow for real-time monitoring of page actions associated with a web page and the effects of the page actions on account data. Specifically, web browsers may be configured to provide contextual notifications associated with user interactions with web pages, in accordance with example embodiments of the present disclosure. The contextual notifications may be generated based on detected page actions, historical transactions data associated with one or more resource accounts, and resource allocation data associated with the resource accounts.

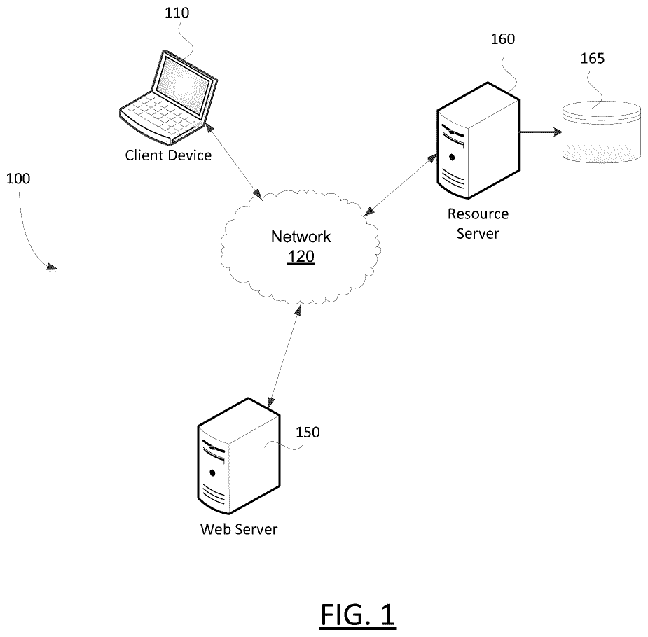

Reference is first made to FIG. 1 which illustrates an example networked computing environment 100 consistent with certain disclosed embodiments. As shown in FIG. 1, the computing environment 100 may include a client device 110, a web server 150, a resource server 160, a database 165 associated with the resource server 160, and a communication network 120 connecting one or more of the components of networked environment 100.

A resource server 160 (which may also be referred to as a server computer system) and a client device 110 communicate via the network 120. In at least some embodiments, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity (e.g., an individual, an organization, etc.) having resources that are managed by or using the resource server 160. For example, the resource server 160 may be a financial institution server and the client entity may be a customer of a financial institution operating the financial institution server. The client device 110 may store software instructions that cause the client device to establish communications with one or more web servers 150 and the resource server 160.

The resource server 160 may track, manage, and maintain resources, make lending decisions, and/or lend resources to a client entity associated with the client device 110. The resources may, for example, be computing resources, such as memory or processor cycles. In at least some embodiments, the resources may include stored value, such as fiat currency, which may be represented in a database. For example, the resource server 160 may be coupled to a database 165, which may be provided in secure storage. The secure storage may be provided internally within the resource server 160 or externally. The secure storage may, for example, be provided remotely from the resource server 160. For example, the secure storage may include one or more data centers storing data with bank-grade security.

The database 165 may include records for a plurality of accounts and at least some of the records may define a quantity of resources associated with the client entity. For example, the client entity may be associated with an account having one or more records in the database 165. The records may reflect a quantity of stored resources that are associated with the client entity. Such resources may include owned resources and, in at least some embodiments, borrowed resources (e.g., resources available on credit). The quantity of resources that are available to or associated with the client entity may be reflected by a balance defined in an associated record such as, for example, a bank balance.

In at least some embodiments, the database 165 may store various types of information in connection with customers of a business entity that administers the resource server 160. For example, the database 165 may store customer profile data and financial account data associated with customers. The customer profile data may include, without limitation, personal information of registered customers, authentication credentials of the customers, account identifying information (e.g., checking account, savings account, revolving credit line, etc.), and information identifying services (e.g., banking services, investment management services, etc.) and/or programs that are offered to the customers by the business entity. The financial account data may include portfolio data relating to portfolios of investments that are held by customers. A customer's portfolio data may include, for example, information identifying actual positions held by the customer in various securities, information identifying a “virtual” portfolio composed of simulated positions held by the customer in various securities, and “watch lists” specifying various securities that are monitored by the customer.

The business entity associated with the resource server 160 may provide services that are accessible to the client entity. For example, the business entity may provide account management services, financial transaction services, and investment management services for the client entity. In at least some embodiments, the resource server 160 may be configured to provide a user interface that allows client devices 110 to access some of the services offered by the business entity. By way of example, the resource server 160 may be configured to provide a website or web-based portal which can be accessed via the client device 110. The website (or portal) may include web content corresponding to various services offered by the business entity, and the resource server 160 may provide the web content for display on the client devices 110. As another example, the resource server 160 may be associated with a software application which may be installed and/or run on the client devices 110. In some embodiments, the resource server 160 may be a backend server associated with software (e.g., mobile app, web application, etc.) which may be accessed on the client device 110. The software may, for example, be a mobile banking or investment management application. A graphical user interface (GUI) associated with the application may present the content corresponding to the services offered by the business entity on a display associated with the client device 110. A customer may interact with the business entity and its service offerings via the GUI of the application.

The web server 150 serves documents (and other resources), which may be in the form of web pages, to the client device 110. The web server 150 may, therefore, function as a website, and may process hypertext transfer protocol (HTTP) requests, serving documents and other resources in response to such requests. An HTTP request may, for example, be issued by an application, such as a web browser, operating on the client device 110. The documents that are served by the web server 150 may include documents of various types including, for example, text-based documents, multimedia documents, videos, and audio files. In at least some embodiments, the documents may be hypertext markup language (HTML) documents.

The web server 150 may be operated by an entity different from an entity operating the resource server 160. The profile(s) stored at the resource server 160 and their associated data may thus be maintained privately at the resource server 160 and not made accessible (e.g., disclosed) to the web server 150. Indeed, as will be described in greater detail below, the supplementary data that is provided by the resource server 160 may be generated based on documents served to the client device 110 from the web server 150, but the resource server 160 provides such supplementary data directly to the client device such that said data is not revealed to the web server 150. In this way, the disclosed embodiments maintain the privacy of user-specific resource data when generating the supplementary data and protect against access of such data by unauthorized third-parties.

The client device 110, the web server 150, and the resource server 160 may be in geographically disparate locations. Put differently, the client device 110 may be remote from the web server 150 and/or the resource server 160. As described above, the client device 110, the web server 150, and the resource server 160 may be computer systems.

The network 120 is a computer network. In some embodiments, the network 120 may be an internetwork such as may be formed of one or more interconnected computer networks. For example, the network 120 may be or include an Ethernet network, an asynchronous transfer mode (ATM) network, a wireless network, or the like.

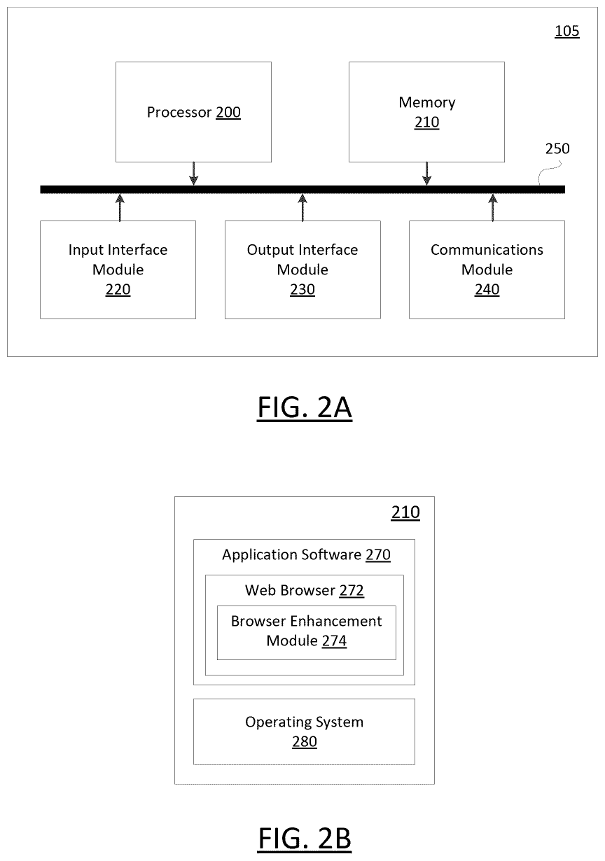

FIG. 2A is a high-level operation diagram of an example computing device 105. In some embodiments, the example computing device 105 may be exemplary of one or more of: the client device 110, the web server 150, and the resource server 160. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned examples of input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communication networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230, and the communications module 240. The operating system 280 may, for example, be Apple™ OS X, Android™, Microsoft Windows™, a Linux distribution, or the like.

The application software 270 adapts the example computing device 105, in combination with the operating system 280, to operate as a device performing particular functions. The application software 270 may, for example, include a web browser 272. The application software 270 may also include processor-executable instructions which, when executed by the processor 200, cause the computing device 105 to interact with the resource server 160 as described herein. Such instructions are referred to herein as a browser enhancement module 274. The browser enhancement module 274 may, for example, be a software module that is provided on the computing device 105 as a plug-in, or extension, of the web browser 272. The browser enhancement module 274 enables one or more application services to interface with the web browser 272. For example, the browser enhancement module 274 may add certain features, enable additional actions, and enhance the functionality of websites that are presented using the web browser 272.

The browser enhancement module 274 is associated with a backend application server. In at least some embodiments, a server which manages resource accounts associated with the customers of a business entity, such as resource server 160 of FIG. 1, may also serve as the backend application server for the browser enhancement module 274. In particular, various functions of the browser enhancement module 274 may be provided, at least in part, by a resource server associated with a bank institution. That is, the resource server may perform backend services of the browser enhancement module 274.

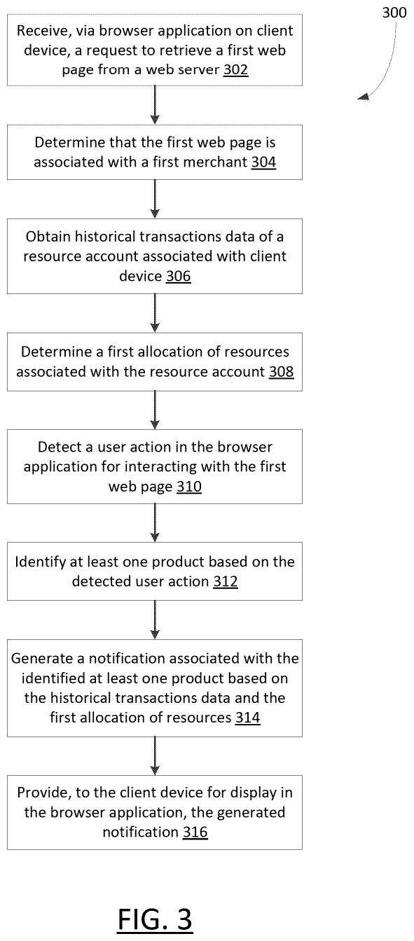

Reference is made to FIG. 3 which shows, in flowchart form, an example method 300 for generating contextual notifications in a web browser session. As a specific and non-limiting example, the method 300 may be implemented in providing contextual notifications associated with account data of a user's resource account within a graphical user interface associated with a browser application.

The operations of method 300 may be performed by a client device (e.g., by software resident on the client device), either alone or in conjunction with one or more computer server systems. For example, a client device that is used for a web browser session may perform one or more client-side operations of method 300 and a server, such as the resource server 160 of FIG. 1, that acts as a backend for a browser enhancement module of a web browser may perform certain server-side operations of method 300. In some embodiments, a client device or a server may perform all of the operations of method 300. In particular, computer-executable instructions stored in memory of a client device (or a server computer) may, when executed by a processor of the client device (or server), configure the processor to perform the operations of method 300. The instructions corresponding to the operations of method 300 may be executed, for example, as part of software, such as a web browser and/or a browser enhancement module, that is operable for providing web browser sessions on the client device.

In operation 302, the processor receives, via a browser application on a client device, a request to retrieve a first web page from a web server. The request may be, for example, a user request to navigate to the first web page during a web browser session. The request may comprise user input for indicating an address associated with the first web page. The user input may be, for example, selection of a hyperlink or a related user interface element, or input of a URL in an address bar associated with the browser application.

In response to receiving the request, the processor obtains document data of the first web page. The first web page is a document that is accessible via the Web and may, for example, be an HTML document, a static document (e.g., PDF file), an email message, and the like. The processor may obtain the document data directly from a web server. For example, the processor may request, via HTTP, to obtain a file that is hosted on a web server (i.e., HTTP request). The web server locates the requested document and sends the document data associated with the document in an HTTP response. The document data of the first web page includes data identifying the document and content items that are contained in the document. In at least some embodiments, the document data may include one or more of: a page title, a resource identifier (e.g., URL), meta description, and source code associated with the first web page. The document data may include, for example, metadata for the first web page, which may be used by the browser application for displaying web page content or for reloading the page.

Upon obtaining the document data of the first web page, the processor is configured to analyze the document data to identify merchant information associated with the first web page. Specifically, the processor determines whether the first web page is associated with a merchant, in operation 304. In at least some embodiments, the processor may perform contextual scans of the document data of the first web page. Based on the scanning, the processor may detect merchant-identifying information. The contextual scanning may be performed by, for example, a document processing module implemented by the processor. The document processing module may be configured to process various types of web documents and capture specific data from the document's content.

The document processing module may receive, as input, document data for the first web page. For example, an HTML file associated with the first web page may be received as input at the document processing module, and the module may perform a contextual analysis based on the text of the HTML file. The document processing module may handle various data processing operations. By way of example, the document processing module may be configured to perform text processing operations, such as tokenization, stemming, feature extraction, etc., on the text of the web page. Additionally, or alternatively, the document processing module may perform image and video data processing operations on multimedia content items contained in the first web page. For example, the document processing module may determine the types associated with multimedia content items in the first web page and apply defined recognition algorithms for detecting faces, objects, etc., in images/videos contained in the first web page.

The document data for the web page forms the basis for identifying merchant-related information in the document. In some embodiments, the processor may perform syntactic analysis on the text of the document to parse identifiers associated with one or more known merchant entities. The processor may access a predefined dictionary of identifiers (e.g., names, symbols, etc.) that are associated with merchants. The dictionary may be derived, for example, based on a database storing information relating to known merchants. The processor may parse identifiers that are associated with known merchants from the document text. For example, the processor may perform textual comparisons between items included in the predefined dictionary and syntactic units (e.g., word, sentence) in the document text.

In at least embodiments, the processor may classify the parsed identifiers to determine whether the identifiers are associated with a particular merchant. For example, the processor may perform textual disambiguation on the parsed identifiers. That is, for each of one or more of the parsed identifiers, the processor may determine which sense of the word (i.e., identifier) is used in the document text. The processor may implement one or more of a variety of techniques for word sense disambiguation, such as dictionary-based methods that use knowledge encoded in lexical resources, supervised machine-learning methods in which a classifier is trained for each distinct word on a corpus of sense-annotated examples, and unsupervised methods that cluster occurrences of words inducing word senses. In some embodiments, the processor may determine one or more domains associated with the first web page. In particular, based on the document data (such as web page text, metadata, etc.), the processor may identify categories or topics that are represented by the content of the first web page. The identified categories/topics of the first web page may inform the textual disambiguation of the parsed identifiers.

More generally, the processor may be configured to implement named-entity recognition (NER) techniques for locating and classifying named entities (e.g., organization name, etc.) that are mentioned in the text of the first web page. For example, the processor may implement a statistical NER system relying on annotated training data or a semi-supervised learning technique such as phrase clustering.

The user associated with the web browser session may own and/or control one or more user accounts. Various page actions which may be performed by the user on the first web page may affect the account data of such user accounts. In particular, the user's page actions in connection with the first web page may cause changes to resources associated with at least one resource account of the user. The processor may be configured to process the user's page actions and resource account data in parallel in order to provide contextual notifications to the user during the web browser session. In operation 306, the processor obtains historical transactions data of a resource account associated with the client device. The resource account is an account that is associated with a user of the client device. For example, the resource account may be an account, such as a bank account, that is owned and/or controlled by a user of the client device. The historical transactions data includes transactions data associated with past transactions conducted by an accountholder in connection with the resource account. In particular, the historical transactions data may include an indication of transactions associated with a plurality of merchants. The historical transactions data may indicate, for each of one or more past transactions, various information about the transaction, such as transaction type, location, merchant data (e.g., name of merchant, sales channel, etc.), date and/or time, transaction amount, and the like.

In operation 308, the processor determines a first resource allocation associated with the resource account. The first resource allocation represents a defined allocation of resources associated with the resource account. In particular, the first resource allocation may be an actual or proposed distribution of the resources that are associated with the resource account. In some embodiments, the first resource allocation may take into account resources that are currently associated with the resource account as well as prospective resources that may be obtained for the resource account. That is, the processor may determine an allocation of the resources that are currently associated (e.g., contained) in the resource account and the resources that may or are expected to be obtained in connection with the resource account.

The first resource allocation may, in some embodiments, be a defined distribution of resources associated with the resource account to multiple categories of resource contribution. The distribution may be defined, for example, by the user associated with the resource account. For example, the resource account may be a bank account and first resource allocation may be a user-defined budget that specifies, for each of one or more categories of resource contribution, a maximum value, or amount, associated with the category. In some embodiments, allocation data for the first resource allocation may be stored in association with the resource account. For example, a computing system (such as the resource server 160) that manages the resource account may be configured to receive user input of allocation data for the first resource allocation and store the allocation data, for example, as user preference data for the resource account.

In at least some embodiments, the first resource allocation represents static account data with which the effects of the user's actions on the first web page on the resource account can be compared. In particular, the processor may monitor the user's page actions and compare, in real-time or substantially real-time, the effects of the page actions to the first resource allocation in order to detect one or more defined conditions in connection with the resource account. Upon detecting a defined condition, the processor may usefully provide graphical indications of the detected condition to the user during the web browser session. In this way, the user may be provided with contextual cues (e.g., pop-up notifications) that inform the user's future page actions in connection with the first web page.

The processor may obtain the historical transactions data and the allocation data for the first resource allocation based on querying a computing system associated with the resource account. Specifically, the processor may generate queries (e.g., using a related API for the computing system) to obtain account data associated with the resource account which may include, among others, the historical transactions data and allocation data for one or more defined resource allocations. The queries may be transmitted by the processor to a remote computing system. The results of the queries for account data may be obtained and interpreted by the processor in order to identify relevant transactions and allocations data.

In at least some embodiments, prior to querying the computing system, the processor may first verify that the user associated with the web browser session is authorized to access the resource account. The processor may, for example, process a login by the user to the resource account to verify that the user is authorized for access, and query the computing system only upon successful authentication of the user. If the user is authenticated, the resource account may be determined to be connected, or linked, to the web browser session. User actions (e.g., page actions) performed by the authenticated user during the web browser session may be monitored to determine the effects of the actions on the connected resource account. The processor may then generate contextual notifications in connection with the connected resource account for web pages that the user interacts with.

In operation 310, the processor detects a user action in the browser application for interacting with the first web page. The user action includes a page action that is performed by the user while visiting the first web page using the browser application. In at least some embodiments, the user action is defined by a page interaction event. A page interaction event may comprise one or more of: a navigation event, a click event, a hover event, a scroll event, a text entry, a selection event, a mouse move event, and the like. For example, the user action may include selection of a user interface element (e.g., a hyperlink, a product image, etc.) associated with a product that is displayed on the first web page. As another example, the user action may include user navigation to a product page for a product that is offered by the merchant associated with the first web page. The processor is configured to detect the user action based on detecting a corresponding page interaction event that is received via the client device.

The historical transactions data and/or the allocation data for the first resource allocation may be obtained in real-time or substantially real-time as the user action is detected, or said data may be obtained and stored in association with the resource account prior to detection of the user action. For example, the account data of the resource account may be obtained from a computing system managing the resource account in real-time or substantially real-time (e.g., by means of database queries in connection with the resource account) responsive to the processor detecting one or more defined user actions in the browser application.

When the user action is detected, the processor identifies at least one product associated with the merchant, in operation 312. In particular, a product from the merchant's catalogue of products may be identified by the processor. The identified product may, for example, be a product that is selected based on, or otherwise associated with, the detected user action. For example, the user action may include a selection event (or click event, hover event, etc.) for selecting a user interface element, such as a graphical representation, associated with a product that is displayed on the first web page.

In operation 314, the processor generates a notification associated with the identified at least one product. Specifically, the notification is generated based on the historical transactions data of the resource account and the first allocation of resources associated with the resource account. In at least some embodiments, the notification is generated responsive to the processor detecting one or more defined trigger conditions. A trigger condition may be a condition relating to at least one of the historical transactions data and the first allocation of resources associated with the user's resource account. That is, the processor may concurrently monitor the user's page actions on the first web page as well as conditions associated with account data of the user's resource account.

In some embodiments, a defined condition may relate to a current quantity of resources associated with a category of resource allocation for the resource account. The processor may be configured to determine a current quantity of resources, such as total cumulative deployed resources (e.g., total expenses), associated with a specific category based on the historical transactions data. The processor may identify a category of resource allocation that is associated with the user action, and compare the current quantity against a respective amount defined for the first resource allocation. For example, the processor may identify a category to which the product associated with the user action belongs, and determine a value of total current expense for said category. If the processor determines that the total current expense satisfies a defined condition (e.g., exceeds or is projected to exceed a threshold amount), the processor may generate a notification to present to the user during the web browser session. The threshold may, in some embodiments, be a quantity of resources defined for the category by the first resource allocation. That is, if the processor determines that the current quantity of resources associated with a category exceeds (or is projected to exceed) a respective amount defined by the first resource allocation, the condition may be determined to be satisfied and a notification associated with the product may be generated accordingly for presenting during the web browser session.

Additionally, or alternatively, a defined condition may relate to type or category associated with the first web page. The processor may determine a type/category of the first web page based on, for example, contextual scanning of the document data of the first web page. The first web page may, for example, be a catalogue or product search results page, a product page, a checkout page, etc. associated with an identified merchant. The notification may be generated based on, at least, the type or category associated with the first web page. In particular, the processor may determine or access a mapping of product types/categories to notifications which may be presented during a web browser session, and the notification may be generated based on the mapping.

In some embodiments, the processor may be configured to obtain historical user activity data in connection with the first web page. The historical user activity data may include a list of past user actions performed by the user on or relating to the first web page. For example, the historical user activity may include previous page visits and interaction events (e.g., a click event, hover event, etc.) associated with the first web page. The historical user activity may also include indications of merchant- or product-related actions performed by the user on the first web page. For example, the historical user activity may indicate, among others, past purchase activities and amounts, viewed products, saved products and/or shopping carts, and the like. Contextual notifications may be generated based at least in part on the historical user activity for the first web page.

The processor provides, to the client device for display in the we browser application, the generated notification, in operation 316. The processor may, for example, transmit an instruction to present the notification in a graphical user interface associated with the browser application. The notification may, for example, be a pop-up notification that is displayed concurrently with the first web page on the browser application. In some embodiments, the notification may be displayed as overlay on top of at least part of the visible portion of the first web page. The notification may be associated with one or more actions which may be performed by the user. In particular, the notification may provide access to certain related user actions in connection with the web browser session. For example, the notification may include user interface elements associated with one or more user actions, such as: dismissing the notification, related page actions for the first web page, navigation to a different web page, and the like.

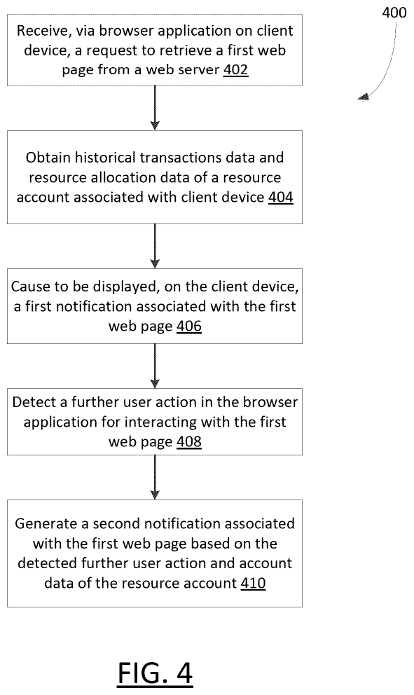

Reference is made to FIG. 4 which shows, in flowchart form, an example method 400 for generating contextual notifications based on user actions associated with a web page on a browser application. As a specific and non-limiting example, the method 400 may be implemented in providing contextual notifications associated with account data of a user's resource account within a graphical user interface associated with a browser application. The operations of method 400 may be performed by a client device (e.g., by software resident on the client device), either alone or in conjunction with one or more computer server systems. The instructions corresponding to the operations of method 400 may be executed, for example, as part of software, such as a web browser and/or a browser enhancement module, that is operable for providing web browser sessions on a client device. The operations of method 400 may be performed in addition to, or as alternatives of, one or more of the operations of method 300.

In operation 402, the processor receives, via a browser application on a client device, a request to retrieve a first web page from a web server. The request is received during a user's web browser session. The request may be, for example, a user request to navigate to the first web page during a web browser session. The request may comprise user input, such as selection of a hyperlink or input of a URL in an address bar, for indicating an address associated with the first web page.

In operation 404, the processor obtains historical transactions data and allocation data for a first resource allocation associated with a resource account. The resource account is an account of a user associated with the web browser session. In at least some embodiments, the processor may first process a login to the resource account using authentication credentials of the user. The account data, including historical transactions data and allocation data for the first resource allocation, may only be retrieved upon successful authentication of the user to the resource account. If the user is authenticated, the resource account may be determined to be connected, or linked, to the web browser session. The historical transactions data and the allocation data are obtained from a computing system that manages the resource account. The historical transactions data includes transactions data associated with past transactions conducted by an accountholder in connection with the resource account. In particular, the historical transactions data may include an indication of transactions associated with a plurality of merchants. The first resource allocation represents an allocation of resources associated with the resource account. In particular, the first resource allocation may be an actual or proposed distribution of the resources that are associated with the resource account into multiple categories of resource contribution.

The processor causes to be displayed, on the client device, a first notification associated with the first web page, in operation 406. For example, the first notification may be displayed via a graphical user interface of the web browser in association with the first web page. The first notification may be displayed responsive to the processor detecting one or more defined trigger conditions relating to the historical transactions data, the allocation data, and a user action detected on the first web page via the browser application. In particular, if the processor determines that a user action, including a page interaction event such as a click event, hover event, etc., causes a current quantity of resources associated with a category of resource allocation to satisfy a defined condition, the first notification may be generated for presenting to the user during the web browser session.

For example, the processor may detect a user action on the first web page that results in a change in a value of total current resource usage for a resource category. If the processor determines that the total current resource usage satisfies a defined condition (e.g., exceeds or is projected to exceed a threshold amount), the processor may generate the first notification to present to the user during the web browser session. The threshold may, in some embodiments, be a quantity of resources defined for the category by the first resource allocation. That is, if the processor determines that the current quantity of resources associated with a category exceeds (or is projected to exceed) a respective amount defined by the first resource allocation, the first notification may be generated accordingly for presenting during the web browser session.

In operation 408, the processor detects a further user action in the browser application for interacting with the first web page. The further user action may be an action that is detected by the processor subsequent to display of the first notification on the client device. In particular, the further user action may include a page action for interacting with a displayed component (e.g., one or more user interface elements) of the first web page.

If the processor determines that the further user action causes the current quantity of resources associated with the category of resource allocation to satisfy a defined condition, a second notification associated with the first web page is generated, in operation 410. In particular, the second notification may be generated based on the detected further user action and account data of the resource account. In some embodiments, the second notification may indicate a change to a current quantity of resources associated with a category of resource contribution that results from the further user action on the first web page. The second notification may be presented in addition to, or as replacement for, the first notification during the web browser session.

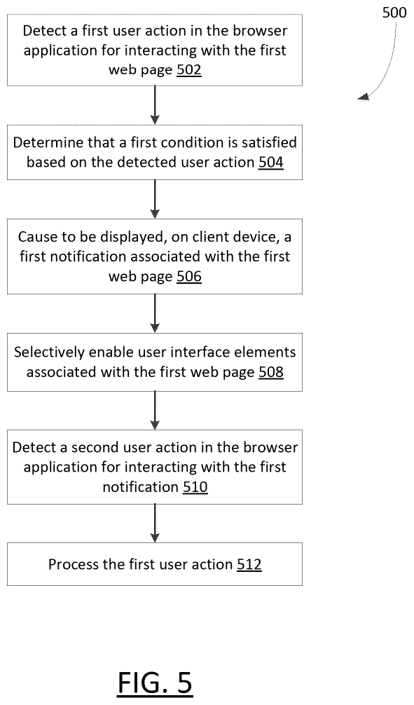

Reference is made to FIG. 5 which shows, in flowchart form, an example method 500 for controlling a user interface associated with a web page. As a specific and non-limiting example, the method 500 may be implemented in providing contextual notifications associated with account data of a user's resource account within a graphical user interface associated with a browser application. The operations of method 500 may be performed by a client device (e.g., by software resident on the client device), either alone or in conjunction with one or more computer server systems. The instructions corresponding to the operations of method 500 may be executed, for example, as part of software, such as a web browser and/or a browser enhancement module, that is operable for providing web browser sessions on the client device. The operations of method 500 may be performed in addition to, or as alternatives of, one or more of the operations of methods 300 and 400.

In operation 502, the processor detects a first user action in the browser application for interacting with a first web page. The first user action may include a page interaction event such as a click event, a hover event, a selection event, etc. that is associated with the first web page. The processor may detect the first user action based on detecting one or more of the user's page interaction events via a client device during a web browser session.

The processor determines that a first defined condition is satisfied based on the detected user action, in operation 504. The first condition may be one or more of the defined conditions described above relating to the historical transactions data and allocation data for a resource allocation associated with a user's resource account. In response to determining that a defined condition is satisfied, the processor causes to be displayed, on the client device, a first notification associated with the first web page, in operation 506. In at least some embodiments, the first notification is caused to be displayed concurrently with the first web page on the browser application. For example, the first notification may be displayed as overlay on top of at least part of the visible portion of the first web page.

In operation 508, the processor selectively enables user interface elements associated with the first web page. In particular, the processor may identify at least one user interface element associated with a page action that is to be prevented. The first notification may be a notification for alerting the user associated with the web browser session that a certain user action in connection with the first web page may lead to a result that satisfies a defined undesirable condition. For example, the first notification may comprise a prompt for the user to acknowledge or dismiss that a user action that is about to be performed in connection with the first web page may or will have a certain undesirable effect with respect to allocation data for a resource allocation associated with the user's resource account. In addition to presenting the notification to the user as an alert or warning, the processor may be configured to temporarily disable certain user interface elements on the first web page to prevent user actions that may increase or exacerbate said undesirable effect. For example, the processor may remove such user interface elements, render but disable selection of the user interface elements, or otherwise prevent access to the associated user actions on the first web page.

In operation 510, the processor detects a second user action in the browser application for interacting with the first notification. The second user action may be an action by the user associated with the web browser session that the user acknowledges or dismisses the effect associated with the first user action. That is, the processor receives, via the client device, user input for indicating that the user desires for the first user action to be processed. For example, the user input may be selection of a user interface element, text input, and the like, for requesting that the first user action be processed. In response to detecting the second user action, the processor proceeds to process the first user action, in operation 512. In particular, upon receiving user input associated with express indication of the user's intention regarding the first user action, the processor handles the first user action. In some embodiments, the processor may enable one or more disabled user interface elements responsive to receiving the second user action. That is, the processor may restore access to one or more selectively disabled user interface elements upon receiving indication of the user's desire to process the first user action.

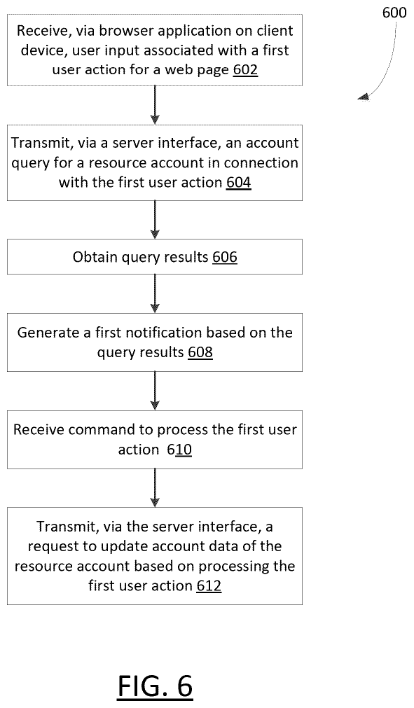

Reference is made to FIG. 6 which shows, in flowchart form, an example method 600 for updating account data of a resource account based on page actions associated with a web page. As a specific and non-limiting example, the method 600 may be implemented in providing contextual notifications associated with account data of a user's resource account within a graphical user interface associated with a browser application. The operations of method 600 may be performed by a client device (e.g., by software resident on the client device), either alone or in conjunction with one or more computer server systems. The instructions corresponding to the operations of method 600 may be executed, for example, as part of software, such as a web browser and/or a browser enhancement module, that is operable for providing web browser sessions on the client device. The operations of method 600 may be performed in addition to, or as alternatives of, one or more of the operations of methods 300 to 500.

In operation 602, the processor receives, via a browser application on a client device, user input associated with a first user action for a web page. The user input may be or include one or more page interaction events such as a click event, a hover event, a scroll event, etc. that is registered via the client device during a user's web browser session.

The processor transmits, via a server interface, an account query for a resource account in connection with the first user action, in operation 604. The resource account is an account owned and/or controlled by the user associated with the client device, and the server interface is associated with a server that manages the resource account. The account query may, for example, comprise a query for account data associated with the resource account. The account data may include, among others, historical transactions data and allocation data for one or more defined resource allocations associated with the resource account. The query may be transmitted using an API associated with the server (or other computing system).

In operation 606, the processor obtains query results associated with the query. The query results may include, for example, requested historical transactions data and/or the allocation data. The processor then generates a first notification based on the query results, in operation 608. In particular, the first notification may be generated responsive to detection of one or more defined conditions relating to account data of the resource account, as described in detail above.

The processor receives a command to process the first user action, in operation 610. Specifically, the processor receives user input for requesting to process the first user action. The user input may, for example, comprise an input for acknowledging or dismissing an alert associated with the first notification regarding the detected one or more conditions associated with the account data. That is, the command may be the user's expression that the first user action is desired to be processed in spite of any undesirable conditions which may result due to the first user action.

In operation 612, the processor transmits, via the server interface, a request to update account data of the resource account based on processing the first user action. The request may be a request to update one or both of the allocation data for a defined resource allocation and historical transactions data associated with the resource account. The request data for the request may indicate, for example, the first user action, a requested change to account data such as historical transactions data and allocations data, an amounted of the requested change, and the like.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor; and
a memory coupled to the processor, the memory storing instructions that, when executed, configure the processor to:
receive, via a browser application on a computing device, a request to retrieve a first web page from a web server;
determine that the first web page is associated with a first merchant;
in response to determining that the first web page is associated with the first merchant:
obtain historical transactions data of a resource account associated with the computing device;
determine a first allocation of resources associated with the resource account;
detect a user action in the browser application for interacting with the first web page;
in response to detecting the user action in the browser application:
identify at least one product associated with the merchant based on the detected user action;
generate a notification associated with the identified at least one product based on the historical transactions data of the resource account and the first allocation of resources; and
provide, to the computing device for display in the browser application, the generated notification.

2. The computing system of claim 1, wherein providing the generated notification to the computing device comprises transmitting an instruction to present the notification in a graphical user interface associated with the browser application on the computing device.

3. The computing system of claim 1, wherein the historical transactions data comprises a list of transactions in connection with the first merchant and wherein detecting the user action comprises determining that the user has navigated to the first web page associated with the first merchant.

4. The computing system of claim 1, wherein detecting the user action comprises detecting that the user has navigated to a product page of a product offered by the first merchant.

5. The computing system of claim 1, wherein the first allocation of resources comprises an indication of a defined quantity of resources associated with one or more categories of resource allocation.

6. The computing system of claim 1, wherein detecting the user action comprises detecting selection of a user interface element associated with a product that is displayed on the first web page.

7. The computing system of claim 1, wherein the instructions, when executed, further configure the processor to obtain historical user activity data in connection with the first web page and wherein the notification is generated based at least in part on the historical user activity.

8. The computing system of claim 1, wherein determining that the first web page is associated with the first merchant comprises at least one of contextual scanning of the first web page or parsing of web page metadata of the first web page.

9. The computing system of claim 1, wherein the instructions, when executed, further configure the processor to determine whether the request is received from an authenticated user associated with the resource account.

10. The computing system of claim 1, wherein generating the notification comprises:
identifying a category of resource allocation that is associated with a user action on the first web page; and
comparing a quantity of resources associated with said category to a respective quantity defined by the first allocation.

11. A computer-implemented method, comprising:
receiving, via a browser application on a computing device, a request to retrieve a first web page from a web server;
determining that the first web page is associated with a first merchant;
in response to determining that the first web page is associated with the first merchant:
obtaining historical transactions data of a resource account associated with the computing device;
determining a first allocation of resources associated with the resource account;
detecting a user action in the browser application for interacting with the web page;
in response to detecting the user action in the browser application:
identifying at least one product associated with the merchant based on the detected user action;
generating a notification associated with the identified at least one product based on the historical transactions data of the resource account and the first allocation of resources; and
providing, to the computing device for display in the browser application, the generated notification.

12. The method of claim 11, wherein providing the generated notification to the computing device comprises transmitting an instruction to present the notification in a graphical user interface associated with the browser application on the computing device.

13. The method of claim 11, wherein the historical transactions data comprises a list of transactions in connection with the first merchant and wherein detecting the user action comprises determining that the user has navigated to the first web page associated with the first merchant.

14. The method of claim 11, wherein detecting the user action comprises detecting that the user has navigated to a product page of a product offered by the first merchant.

15. The method of claim 11, wherein the first allocation of resources comprises an indication of a defined quantity of resources associated with one or more categories of resource allocation.

16. The method of claim 11, wherein detecting the user action comprises detecting selection of a user interface element associated with a product that is displayed on the first web page.

17. The method of claim 11, further comprising obtaining historical user activity data in connection with the first web page and wherein the notification is generated based at least in part on the historical user activity.

18. The method of claim 11, wherein determining that the first web page is associated with the first merchant comprises at least one of contextual scanning of the first web page or parsing of web page metadata of the first web page.

19. The method of claim 11, further comprising determining whether the request is received from an authenticated user associated with the resource account.

20. The method of claim 11, wherein generating the notification comprises:
identifying a category of resource allocation that is associated with a user action on the first web page; and
comparing a quantity of resources associated with said category to a respective quantity defined by the first allocation.
